(19) United States
(12) Patent Application Publication
(10) Pub. No.: US 2005/0072455 A1
(43) Pub. Date: Apr. 7, 2005

(54) Glass solar panels

(75) Inventors: Peter F. Gerhardinger, Maumee, OH (US); Randall L. Bauman, Curtice, OH (US)

Correspondence Address: Marshall & Melhorn, LLC, 8th Floor, 4 Seagate, Toledo, OH, 43604, US

(73) Assignee: Engineered Glass Products, LLC

(21) Appl. No.: 10/403,924

(22) Filed: Mar. 26, 2003

Related U.S. Application Data
(60) Provisional application No. 60/369,962, filed on Apr. 4, 2002.

(51) Int. Cl. H02N 6/00

(52) U.S. Cl. 136/243

(57) ABSTRACT

Glass solar panels are provided for producing the panels, which convert light into electricity for storage or powering electrical loads. The panels can also be used as architectural building elements. Included in the panels are electricity generating solar layers that are deposited between bus bars and on conductive coatings that have been previously deposited on the panels. The electricity is transmitted externally by metallic tabs that have been deposited on the bus bars. Subsequently, the tabs are electrically attached to glazing channels, which are electrical connection means for storage and loads. The bus bars, which preferably are copper, are deposited on the coated glass through a novel circularly rotating or inline heating head and mask apparatus. Depending on the application, this assemblage could be configured as insulated glass (IG) units, laminated glass panels, or panel combinations.

### RELATED APPLICATIONS

This application claims the benefit of U.S. Provisional Patent Application Ser. No. 60/369,962, filed Apr. 4, 2002, and U.S. patent application Ser. No. 10/256,391, filed Sep. 27, 2002, which applications are incorporated herein in their entirety.

### BACKGROUND OF THE INVENTION

The present invention relates generally to glass solar panels that can be used for the generation of electricity and for architectural building elements. More particularly, the present invention deals with glass solar panels, where solar layers are disposed onto surfaces of electrically conductive coatings that are disposed onto glass sheets in laminate structures, insulated glass (IG) units, or combinations thereof. Most particularly, the present invention deals with improving electrical connections to and within glass solar panels.

The generation of electricity, by way of solar cell technology, has been developing over the last thirty years. However, solar cell technology could still be improved in various ways, for example: (1) the electrically conductive coating could be disposed more uniformly onto the glass sheet, (2) the electrical connection to the electrically conductive coating that is disposed onto the glass sheet could be made physically simpler and more robust, (3) electrical conduction of the electrical connections could be improved, and (4) the connections could be produced less expensively.

Architectural applications could benefit from improvements in the use of glass solar panels as structural members if the external electrical connections to individual glass panels could be made more robust while multiple glass solar panels could be more easily interconnected by interconnection through glazing channels.

In addition, more efficient architectural glass solar panel, for the generation of electricity from light, could be produced if it was better able to take advantage of improvements in the deposition of the electrically conductive coatings, which are now available. In the past, spray-coating techniques delivered non-uniform coatings, which resulted in less reliable electrical connections and less efficient electricity generation. Recently, the deposition of the coatings has improved through the use of chemical vapor deposition (CVD), which allows for improvements in electrical connections and electricity generation.

Electricity generating glass solar panels are typically formed by disposing electrically conductive; doped tin oxide on an interior surface of laminate structures or IG units. These structures/units typically are connected to one or more solar layers, where exposure to light can provide electricity for homes and businesses. Commercial buildings, sloped glazing in atria, canopies, and general fenestration applications, could benefit from the use of architectural glass solar panels but conventional connection means have limited such usage. Expanding the adoption of this technology, however, is hampered by the complexity of safely, reliably, and cost effectively combining glass and electricity.

Interconnections between the glass solar panels, typically, have not been designed as part of an integrated connection circuit. For example, where bus bars have been used, they have typically been screen-printed or fired, conductive silver frits. These may exhibit poor adhesion to the glass and result in rigid electrical terminations at the peripheral edge of the glass, which: (1) makes them vulnerable to mechanical flexing, (2) can expose them to condensation, and (3) typically are expensive. In addition, metallic tapes, with adhesive backing, may be readily applied. However, the tapes possess poor conduction properties and the adhesive can dry out and, subsequently, electrically break down.

As an example, U.S. Pat. No. 2,235,681 to Haven et al., teaches the attaching of metal bus bars to a glass sheet as it applies to structural solder elements but not for glass solar applications.

In the crystalline solar cell technology area, ways have been sought to dispose metal-on-glass. U.S. Pat. No. 6,065,424 to Shacham-Diamand et al., teaches thin metal film coatings sprayed onto glass by use of an aqueous solution and then the electrically conductive coatings are annealed.

In U.S. Pat. No. 4,511,600 to Leas, a conductive metal grid is deposited atop a crystalline solar cell by the use of a mask and orifices (without the use of gas or air pressure to impart dispersion or velocity to the metal particles). The '600 patent also advocates the use of a powdered metal that is heated to a molten temperature in a refractory crucible. In U.S. Pat. No. 4,331,703 to Lindmayer, a conductive metal is flame sprayed onto a silicon solar cell.

In U.S. Pat. No. 4,297,391, also to Lindmayer, particles of a material are formed at a temperature in excess of the alloying temperature of the material and the silicon, and then the two are sprayed onto the surface of the glass at a distance, which causes the material and the silicon to firmly adhere to the surface. The '391 patent also teaches the use of a mask.

As another example, in order to connect wiring to the glass solar panels (as well as electrically heated glass panels), it is common for holes to be drilled in the glass panels at the time of manufacturing, as well as in a frame that is often used to hold the panels, or at the time of installation and termination of wiring that is done in the field. When the assembly of the glass solar panels is completed, some of the wiring and associated parts are visible to users of these panel systems. Termination of system wiring to existing facility electrical services, as well as on-site glazing operations, is not done with the integrated connection circuit approach in mind.

Some of the key factors which should be considered in designing an integrated connection circuit are: (1) ease of installation, (2) redundancy of the wiring, since changing individual glass solar panels is quite difficult and expensive, (3) ease of assembly of the complete system, (4) control of unwanted moisture, (5) minimization of damage to the panels, (6) reduction of voids in the glazing, (7) thermal overload protection, and (8) reliability of the total system. Thus, those skilled in the art continued to seek a solution to the problem of how to provide better glass solar panels.

### SUMMARY OF THE INVENTION

The present invention relates to improvements in the manufacturing and application of glass solar panels. Glass solar panels are provided that, if exposed to light, will generate electricity for storage or powering electrical loads and can be used as architectural building elements. The glass-solar panels are interconnected by an integrated connection circuit that includes electricity generating solar layers, which transmit the electricity to conductive coatings, on the glass solar panels, where bus bars have been deposited on the coated glass by way of a circularly rotating or inline heating head and mask apparatus. Each bus bar transmits the electricity externally by way of a metallic tab that is deposited on it, where the tabs extend from the panels' peripheral edges.

Subsequently, the tabs are electrically attached to glazing channels, which are the electrical connection means for the electrical loads. Depending on the application, this assemblage could be configured as insulated glass (IG) panels, laminate structures, or combinations of the two.

Further objects and advantages of the present invention will become apparent to those skilled in the art from the following detailed description of preferred embodiments and appended claims, when read in light of accompanying drawings forming a part of a specification, wherein like reference characters designate corresponding parts of several views.

### BRIEF DESCRIPTION OF THE DRAWINGS

FIG. 1a is a schematic of an interconnection of a glass solar panel and a first glazing channel in accordance with the present invention;

FIG. 1b is a schematic of an interconnection of a glass solar panel and a second glazing channel in accordance with the present invention;

FIG. 2 is a cross sectional view at a peripheral edge of an insulated glass solar panel in accordance with the present invention;

FIG. 3. is a cross sectional view at a peripheral edge of a laminated glass solar panel in accordance with the present invention;

FIG. 4a is a diagrammatic view of a circularly rotating heating head and mask apparatus in accordance with the present invention;

FIG. 4b is a diagrammatic view of an inline heating head and mask apparatus in accordance with the present invention;

FIG. 4c is a perspective view of a belt-based inline heating head and mask apparatus in accordance with the present invention;

FIG. 4d is a top plan view of the belt-based inline heating head and mask apparatus of FIG. 4c;

FIG. 4e is a side plan view of the belt based inline heating head and mask apparatus of FIG. 4c;

FIG. 5 is a cross sectional view of an installation of a laminated glass solar panel and a base setting block within a first glazing channel in accordance with the present invention;

FIG. 6a, is a cross sectional view of the laminated glass solar panel and the base setting block in a non-abutting/non-clasped position in accordance with FIG. 5;

FIG. 6b is a cross sectional view of the laminated glass solar panel and the base setting block in a fully abutting/clasped connection position in accordance with FIG. 5;

FIG. 6c is a perspective view of the laminated glass solar panel and the connection clip in accordance with FIG. 6b;

FIG. 7 is a side view of electrical and mechanical connections of a laminated glass solar panel in accordance with the present invention;

FIG. 8 is a side view of an interconnection of multiple laminated glass solar panels in accordance with the present invention;

FIG. 9 is a side and a bottom view of a wiring method showing a push-on connector and interconnection wires in accordance with the present invention; and

FIG. 10 is a cross sectional view of an installation of a glass solar panel within the second glazing channel in accordance with the present invention.

### DESCRIPTION OF THE PREFERRED EMBODIMENTS

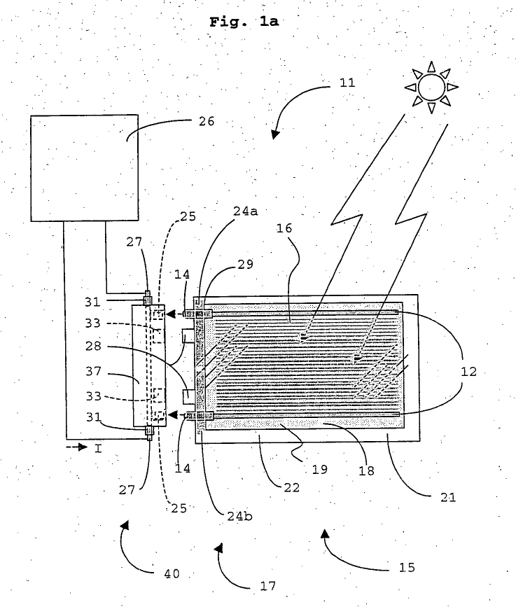

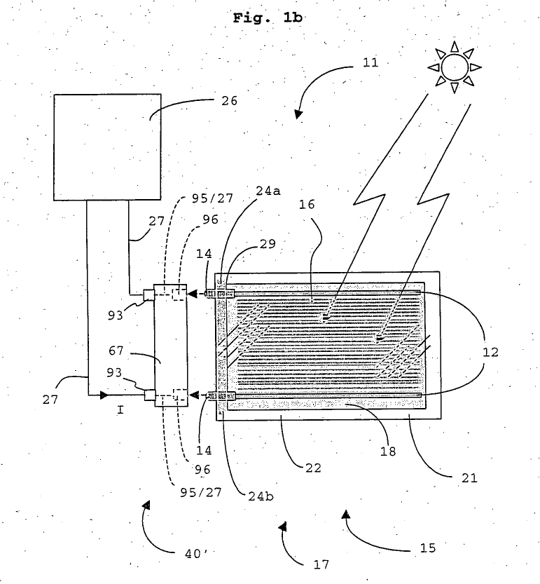

There is shown in FIG. 1a a schematic of the integrated connection circuit 11 in accordance with the present invention. Solar light, radiating onto a glass solar panel 15, generates electrical current (I) in solar layers 16 that are disposed onto an electrically conductive coating surface 19 of an electrically conductive coating 18. The coating 18 is, in turn, disposed onto a major surface 21 of the glass sheet 22, for example, clear soda-lime, low iron soda-lime, and borosilicate glass. The solar layers 16 may comprise amorphous silicon, germanium, or cadmium telluride. The electrically conductive coating 18 comprises a doped metal oxide.

Disposed onto the electrically conductive coating surface 19 are at least two bus bars 12, which are in electrical contact with the solar layers 16 and the electrically conductive coating 18. The bus bars 12 preferably comprise copper, which is a good conductor, although other suitable conductive metals like silver may be used. If preferred, the bus bars 12 may be tapered toward a glass panel peripheral edge 17 of the glass sheet 22, and/or could be tapered on end. Further, metallic tabs 14, which extend beyond the glass panel peripheral edge 17 of the glass solar panel 15, are disposed onto and are in electrical contact with the bus bars 12. An extended portion of the metallic tabs 14, so produced, is readily conductively affixed to external wiring as part of the integrated electrical connection circuit 11.

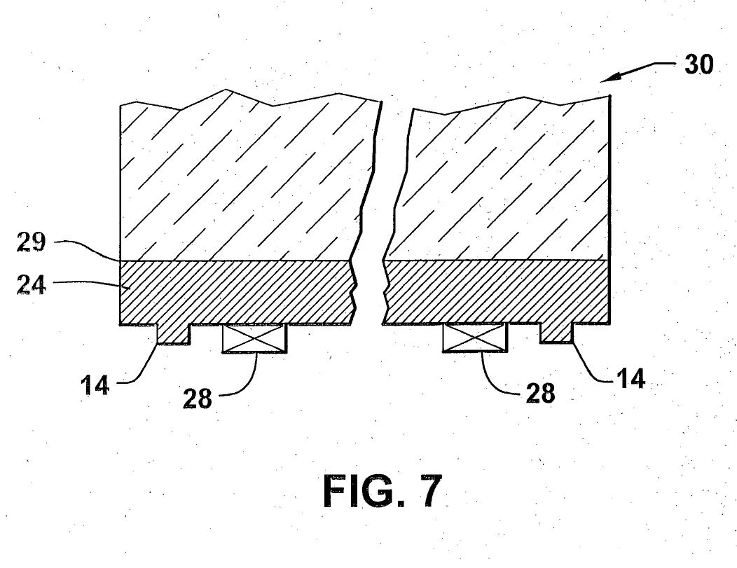

Also shown in FIG. 1a is a first glazing channel 40 where the glass solar panel 15 can be mechanically mounted and electrically connected to other glass solar panels 15. Panel setting blocks 28, on the glass solar panel 15, mate with base setting indentations 33 to provide the mechanical mounting for the glass solar panels 15 within a base setting block 37 (also shown in FIG. 7.) Portions of metal foil 24a, 24b are disposed within the glass solar panel 15, from a glass panel peripheral edge 17, up to a sight line 29, and onto the metallic tabs 14. The metallic tabs 14 and foil 24 electrically connect to the first glazing channel 40 by being clasped by the connection clips 25. Insulating sleeves 31 and channel conductors 27 allow the glass solar panel 15 to be connected to additional glass solar panels 15. Note that the use of the metal foil 24 as described here may be applied to other glazing channels and that the channel conductors 27 are electrically connected to the clips 25.

Consequently, the electrical current (I) that is generated in the solar layers 16 is conducted through the first glazing channel 40, by way of the channel conductors 27 and connection clips 25. Since the connection clips 25 clasp the metallic tabs 14, the electrical current (I) passes through the bus bars 12, the metallic tabs 14, the connection clips 25, and the first glazing channels 40. Outside of the first glazing channels 40 the electrical current (I) is available for storage in, for example, a fuel cell, or for powering an electrical load 26.

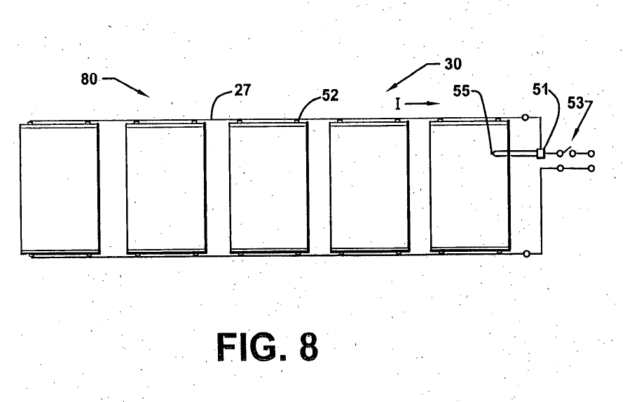

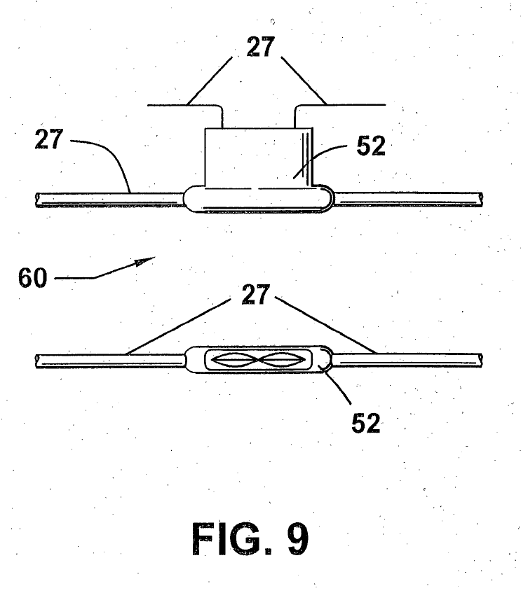

FIG. 1b is similar to FIG. 1a except that a second glazing channel 40′ is employed. Here the metallic tabs 14 attach to spade connectors 96 that are electrically connected to channel conductors 27. Note that channel conductors 27 may be interconnected in glazing channels 40, 40′ or between various glass solar panels 15 by way of push-on connectors 52, like those shown in FIGS. 8, 9 as multiple panel wiring 60.

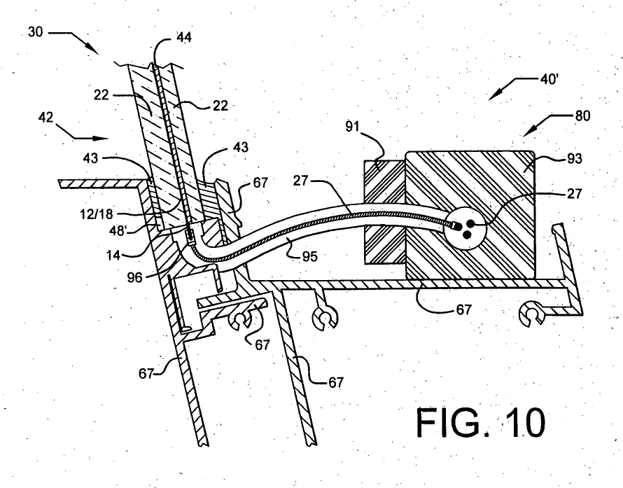

In FIG. 1b the channel conductors 27 are encased in channel conduit 95 that act as a moisture barrier and electrical insulation pathway to conductor blocks 93 (shown in more detail in FIG. 10.) The conductor blocks 93 are one of the means to interconnect conductors 27 between the glass solar panels 15 and the electrical loads 26 that accept the solar generated electricity. Note that the various parts of the second glazing channel 40′ are disposed on or contained within a channel frame 67.

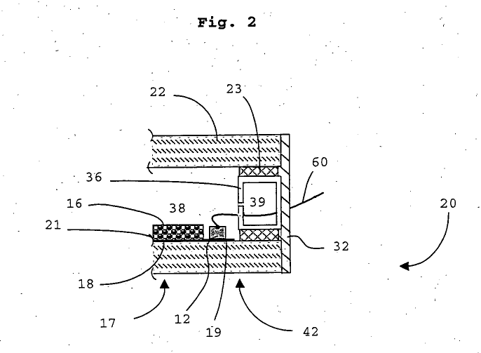

FIG. 2 illustrates a cross sectional view at a glass panel peripheral edge 17 of an insulated glass solar panel 20 in accordance with the present invention. In this aspect, the glass sheet 22 and the coated glass sheet 42 are in a parallel spaced apart relationship and separated by a primary seal 23, a spacer tube 36, a secondary tube 32 (these three parts being conventionally known as a seal unit) having a cavity 39, the seal unit being disposed around a periphery therebetween. The primary seal 23 could comprise polyisobutyl, the spacer tube 39 could comprise a metal, a wire lead 60 could be dressed through the spacer tube 39 and the secondary seal 32, which could comprise polysulfide. A space 38 may be evacuated, filled with air, argon, or other like atmospheres at various pressures. A desiccant may fill the cavity 39 so as to remove moisture that might enter the space 38.

Also shown in FIG. 2 is that an electrically conductive coating 18 has been deleted near the edge of a coated glass sheet 42 so that the primary seal 23 makes a water tight seal that can withstand temperature swings that are experienced by architectural panels 20.

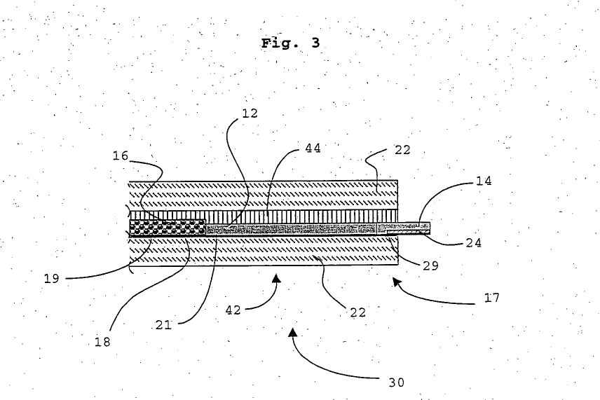

FIG. 3 illustrates a cross sectional view at the glass panel peripheral edge 17 of the laminated glass solar panel 30 in accordance with another aspect of the present invention. The electrically conductive coating 18 is disposed onto the electrically conductive coating surface 19 of the coated glass sheet 42. In turn, the solar layers 16 and the bus bar 12 are disposed onto the electrically conductive coating surface 19 of the electrically conductive coating 18, wherein the solar layers 16 and the bus bars 12 are in electrical contact with one another.

Further, the metallic tab 14 is disposed onto each bus bar 12, where a portion of the metallic tabs 14 extend beyond the glass panel peripheral edge 17 of the laminated glass solar panel 30. Subsequently, the metal foil 24 is disposed on and is in electrical contact with the metallic tab 14, while also being disposed on and in electrical contact with the coating 18 from the peripheral edge 17 of and within the laminated glass solar panel 30, up to the sight line 29. To complete an assemblage of the laminated glass solar panel 30 thus described, is brought together with the glass sheet 22 while an interlayer 44 of polymeric 25 material is disposed therebetween. The interlayer 44 of polymeric material may comprise polyvinyl butyral (PVB).

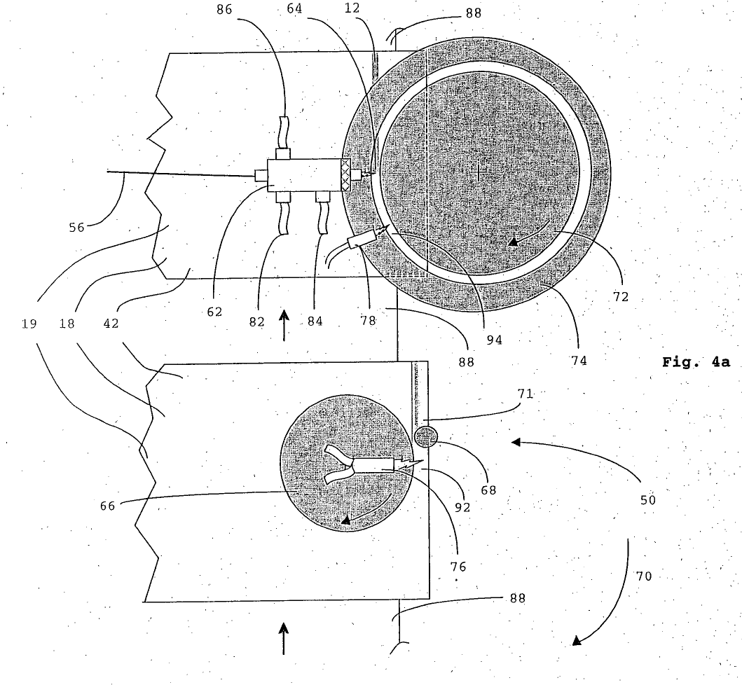

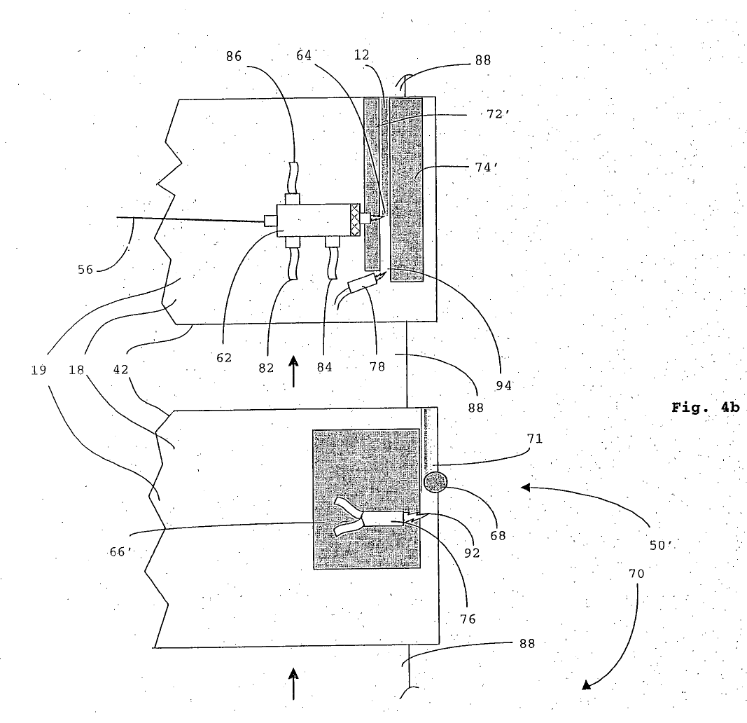

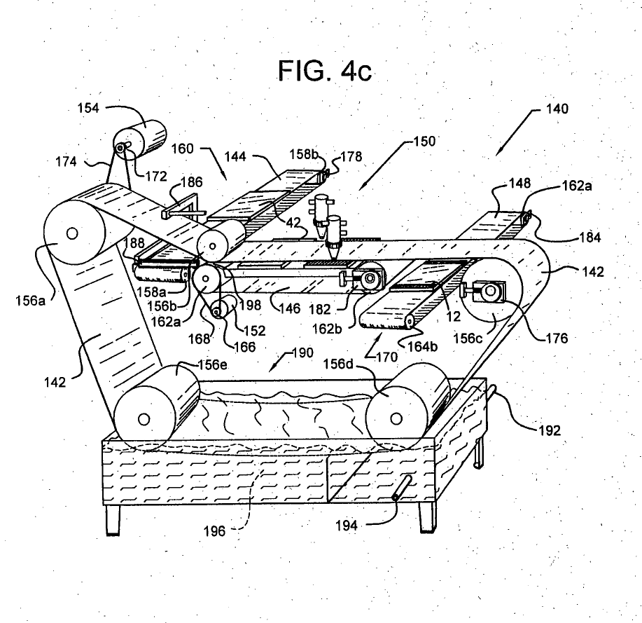

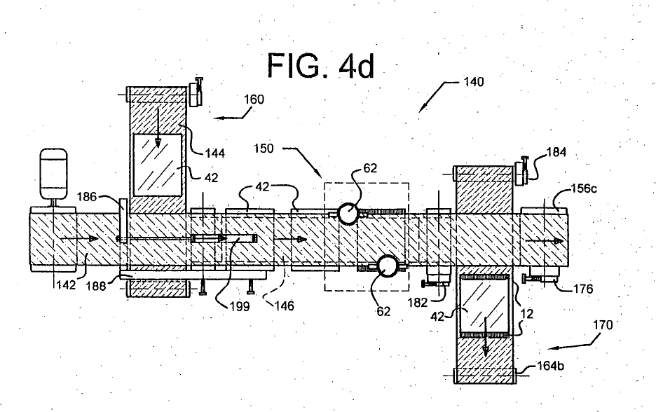

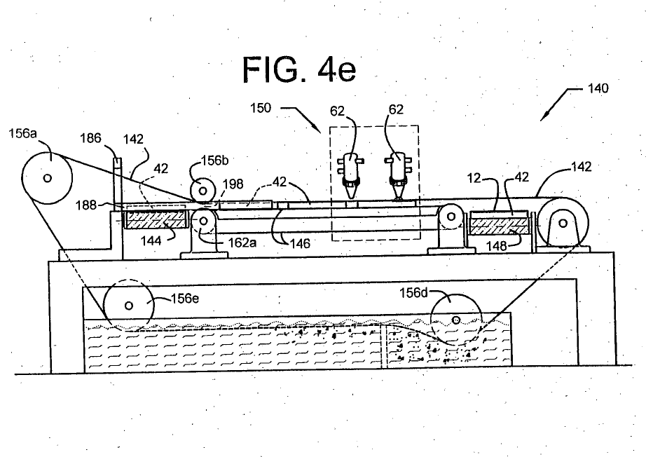

FIG. 4a, which involves the deposition of the bus bars 12 onto the coating 18 that is deposited on the glass sheet 22, illustrates a diagramatic view of a circularly rotating heating head and mask apparatus 50 in accordance with yet another aspect of the present invention. The bus bars 12, as shown in FIGS. 1a and 1b, function to electrically connect the metallic tabs 14, which are the exterior connections for transmitting the electrical current (I) from the solar layers 16 of the glass solar panels 20, 30. As a result, the current (I) transmitted from the solar layers 16 may used by electrical loads.

FIG. 4a illustrates the deposition of bus bars 12 on the coating surface 19 of the coated glass sheet 42, which may be deposited through the use of improved deposition methods in accordance with further aspects of the invention. For example, the coating deposition may comprise chemical vapor deposition, where the coating 18 is deposited onto the major glass surface 21 of the glass sheet 22. The coated glass sheet 42 may then be exposed to a preheat zone 70 upstream and, if “edge deletion” is required, the conveyor 88 transports the coated glass sheet 42 to a circular edge mask 66. While moving within the circular edge mask 66, a first area 92 of the coated glass sheet 42 is heated by a coating heater 76. The coating heater 76 could comprise, as examples, an oxyacetylene burner, a plasma device, an electric arc gun, or a flame spray gun.

In the first area 92, temperatures up to and about 1300 degrees Fahrenheit may be attained in order to heat, thermally shock, and evaporate away the electrically conductive coating 18.

Edge deletion may also be achieved without the use of the edge mask 66. This may be accomplished through precise placement of the heat, thermal control, and set up of the coating heater 76, such that the coating 44 is precisely thermally shock heated and evaporated.

By either edge deletion method, a residue of the electrically conductive coating 44 is formed and may, subsequently, be removed by a coating remover 68, for example, a buffer or a burnishing tool. The coating remover 68 may be required for the IG solar panels 20 (shown in FIGS. 2a and 2b) to establish a better surface for sealing in the atmosphere within the space 38. As a result, this process produces a deleted edge 71, as shown in FIG. 4a.

Next, as FIG. 4a also illustrates, the coated glass sheet 42 is conveyed to a circular inner mask 72 and a circular outer mask 74 where a second area 94 of the coated glass sheet 42 is defined therebetween and where dimensional control of the placement, thickness, tapering, and height of the bus bars 12 is achieved by way of, for example, reducing flame temperature, height and separation of the masks 72 and 74, angle of deposition of the molten metal 64, speed of the conveyor 88, spray width, temperature, and velocity of the molten metal 64.

Heating is achieved by a reducing flame 78 that heats the second area 94 in a stoichiometric atmosphere, where oxidation of a molten metal 64 is controlled during bus bar 12 deposition, while not fracturing or de-tempering the coated glass sheet 42. The reducing flame 78 could comprise oxyacetylene or hydrogen. As a result, the second area 94 is taken to a temperature of about 500 degrees Fahrenheit.

Subsequently, a metal feeding and heating device 62, which may be supplied by gas one 82, gas two 84, and gas three 86, feeds conductive metal 56, preferably in the form of a wire (note that the metal 56 could be a powder or other form and the device 62 an electric arc or flame spray gun), melts the conductive metal 56, and then propels and impinges particles of the molten metal 64 in a predetermined manner, for example, a uniform manner, onto the second area 94. The metal feeding and heating device 62 preferably comprises a plasma gun, while the three gases 82, 84, and 86 preferably comprise oxygen, air, and acetylene, respectively, and the conductive metal 56 preferably comprises copper.

Imparting a high velocity to the molten metal particles 64 results in the bus bars 12 being uniformly formed on, and adhering strongly to, the electrically conductive coating 18. The formation of the bus bar 12 occurs, for example, near the glass panel peripheral edges 17, before the laminated glass solar panel 30, as shown in FIG. 3, or the IG solar panels 20 and 20′, as shown in FIGS. 2a and 2b, are fully assembled. This results in robust external connectivity, where the bus bars 12 possess good ohmic conductivity themselves and also in relation to the electrically conductive coating 18.

Added advantages of the circularly rotating heating head and mask apparatus 50 are that its rotation and size allow for: (1) dissipation of built up heat, (2) the excess molten metal 64 to be scraped, brushed, or blown clean, and (3) accurately depositing the molten metal 64 onto the electrically conductive coating 18 so as to shape the bus bars 12. The shaping of the bus bars 12, if so preferred, may be tapered toward the glass panel peripheral edge 17 and/or tapered on end, as well.

Further, the circularly rotating heating head and mask apparatus 50 accurately controls the thickness of the resulting copper bus bars 12. The thicker the bus bars 12; as shown in FIGS. 1a and 1b, the higher the electrical current (I) that can be conducted through the bus bars 12. Consequently, the higher the electrical current (I) that can be supplied by the glass solar panels, the greater the power that can be delivered by the electrically conductive glass solar panels 15. Also, the use of copper as the bus bar 12 material is less expensive than silver. However, the present invention may be practiced where silver or other conductive metals comprise the bus bar materials.

An additional advantage of this process is that it allows the bus bars 12 to be deposited after thermal tempering of the glass solar panels 15. Although not wishing to be bound by any theory, it is believed that there is no alloying of the molten metal 64, for example, copper, with the electrically conductive coating 18, since the electrically conductive coating 18 is highly chemically inactive and stable. The electrically conductive coating 18 preferably comprises tin oxide.

To form the bus bars 12, the circularly rotating heating head and mask apparatus 50 of the present invention does not use an aqueous solution. Instead, it heats and shapes the bus bars 12 onto the electrically conductive coating 18 by melting the conductive metal 56, and imparting pressure, through the gasses one 82, two 84, and three 86, to impinge, at a high velocity, the molten metal 64 onto the heated and masked second area 94 on the electrically conductive coating 18.

Further, the metallic tabs 14 may then be readily conductively affixed to external wiring, possibly channel conductors 27, as part of the integrated connection circuit 11. The bus bar deposition thus described, may also be used, to form IG solar panels 20, 20′, laminated panels 30, or combination thereof.

Illustrated in FIG. 4b is an inline heating head and mask apparatus 50′ that is also capable of edge deletion and capable of disposing the bus bar 12 on the coated glass sheet 42. If edge deletion is required, the coated glass sheet 42 moves on the conveyor 88 so that the edge of the coated glass sheet 42: a) may be preheated in the preheat zone 70, b) be thermally shocked at the first area 92, and c) have the coating 18 removed by a coating remover 68, which, for example, may be a buffer or a burnishing tool, and d) thus forming the deleted edge area 71. This process is similar to that described above for the circularly rotating heating head- and mask apparatus 50, with the exception that an inline edge mask 66′ replaces the circular edge mask 66.

Note that edge deletion may also be achieved by the apparatus 50, 50′ without the use of the edge masks 66, 66′. This may be accomplished through precise placement of the heat and thermal control, and set up of the coating heater 76, such that the coating 18 is precisely thermally shock heated. This process may be required by the IG solar panels 20, 20′ (shown in FIGS. 2a and 2b) to establish a better surface for sealing in the atmosphere within the space 38.

As the coated glass sheet 42 moves further on the conveyor 88, the bus bar 12 can be disposed on the coating 18 in a similar manner to that described above for the circularly rotating heating head and mask apparatus 50, except that an inline inner mask 72′ and an inline outer mask 74′ are used instead of the circular masks 72 and 74. The inline masks 72′ and 74′ can also result in the same precise formation of the bus bars 12 as the circularly rotating heating head and mask apparatus 50.

A variant of the inline heating head and mask apparatus 50′ is a dual belt based inline heating head and mask apparatus 140 that is shown in FIGS. 4c-4e.

The apparatus 140 comprises: 1) a work piece input area 160, including a first belt 144, first rollers 158, and a first speed and tension adjuster 178, 2) a second belt 142, second rollers 156, and a second tension adjuster 16, being driven by second motor 154, second motor pulley 172, motor belt two 174, 3) a third belt 146, third rollers 162, and a third tension adjuster 182, and being driven by third motor 152, third motor pulley 166, and motor belt three 168, 4) a thermo spray area 150, 5) a work piece output area 170, including a fourth belt 148, fourth rollers 162, and a fourth speed and tension adjuster 184, and 6) an overspray removing device 190.

This inline apparatus 140 may also be practiced by employing other means for driving the belts, for example, sprocket gears and, chains, racks and pinions, and the like, while still remaining within the scope and spirit of the present invention.

In operation, an incoming coated glass sheet 42 is conveyed by the first belt 144 to an adjustable stop 188. Note that the coating 18 is on a side of the coated sheet 42 that will make direct contact with the second belt 142. Note also that the stop 188 is capable of adjustment so as to position varying sizes of coated glass sheets 42 at the discharge end of the first belt 144.

Upon reaching the stop 188, the coated glass sheet 42 is positioned inline with a roller area 198 that is between the second belt 142 and the third belt 146 while centrally spanning the second belt 142. The belts 142, 146, which operate in a parallel spaced apart manner, wherein the width of the second belt 142 is chosen to be less than the width of the sheet 42 so as to allow the second belt 142 to act as a mask while exposing opposite edges of the coating 18 on the sheet 42. Note that the dual belt based inline heating head and mask apparatus 140 forms the bus bars 12 near the glass panel peripheral edge 17 so that the inline outer mask 74′ may not be required.

Subsequently, a cylinder 199 (shown in FIG. 4d) causes an indexer 186 to urge the sheet 42 into the roller area 198 between second belt roller 156b and third belt roller 162a so as to convey the sheet 42 in a direction toward the thermo spray area 150. Note that the linear speeds of the belts 142, 146 being adjusted to be approximately the same by the respective adjusters 176, 182 and that the sheet 42 is held in place by a clamping force that is imposed by the opposing belts 142, 146. The cylinder 199 may be realized by any means that is conventional in the art to properly push or pull the indexer 186.

Upon reaching the thermo spray area 150, the exposed opposite edges of the sheet 42 may be heated by at least one reducing flame 78 (not shown but similar to those illustrated in FIGS. 4a, 4b) and impinged by at least one metal feeding and heating devices 62, so as to dispose molten metal 64 onto the opposite edges of the coated sheet 42. The bus bar deposition operation is accomplished in much of the same manner as that used by the circular and inline heating head and mask apparatus 50, 50′ and results in the deposition of the bus bars 12 at the opposite edges of the coated glass sheet 42.

Following bus bar deposition in the thermo spray area 150, the sheet 42 is conveyed to a fourth belt 148 having fourth belt rollers 164 and fourth speed and tension adjuster 184 and driven by a means (not shown) that is similar to the previously described motor, pulley, and belt, which in turn conveys the sheet 42 to a work piece output area 170. After drop-off of the sheet 42 onto the fourth belt 148, the second belt 142 may be exposed to the overspray removing device 190 in order to remove any conductive metal overspray that may have been deposited on the second belt 142.

The overspray removing device 190 may be, for example, a tank containing a coolant 196 and having an outlet 192 and an inlet 194, where the overspray is removed by thermal shock and scraping. However, the present invention may be practiced where the overspray removing device 190 is at least one fan, scraper, or the like.

The dual belt based inline heating head and mask apparatus 140 is designed to produce panels 15 (note that solar panels 15 may be any one or a combination of solar panels 20, 20′, 30) in a fast and simple manner. In these applications a high speed, low cost process is advantageous and the apparatus 140 is capable of achieving those goals while producing high quality electrical connectivity to the coating 44. However, the apparatus 140 may be used for producing panels other than solar panels 15, for example, heated glass and burner applications where glass, ceramic, and glass-ceramic substrates may be used.

Although not shown in FIGS. 4c-e, edge deletion could be performed on the coated glass sheet 42, prior to the thermo spray operation 150, within the belt based inline heating head and mask apparatus 140. Edge deletion would be accomplished in a manner similar to that discussed earlier for the inline heating head and mask apparatus 50′ and shown in FIG. 4b.

In the present invention, the masks 66, 66′, 72, 72′, 74, 74′, 142 may comprise steel with a layer of chrome plating disposed on the steel. This has been found to inhibit the adhesion of copper and other metals to the masks 66, 66′, 72, 72′, 74, 74′, 142 thus allowing a simple spring loaded scraper to continually clean the overspray from the masks 66, 66′, 72, 72′, 74, 74′, 142 during production of the bus bars 12. This operation allows the overspray and dust of the conductive metal 56 to be collected and re-sold.

The present invention may further deposit soft electrically conductive materials (not shown) that include metal and metal oxides, often in combination with each other, onto the bus bars 12, following bus bar deposition on the coating 18. Note that the deposition of soft electrically conductive materials would also apply to all heating head and mask apparatus 50, 50′, 140.

Examples of the soft conductive materials are silver based systems like (metal oxide/silver/metal oxide) and variants including double silver stacks and indium-tin-oxide (also known as ITO.) All constructs of the bus bars 12, metallic tabs 14 and the panels 20, 20′, and 30 that have been disclosed herein apply with the addition of the deposition of the soft conductive materials.

The soft coatings may be deposited in a vacuum deposition process like that produced by DC Magenetron Sputtering (incorporated herein by reference) after the bus bars 12 are deposited on the coatings 18. For example, these soft coatings may be copper traces that would conduct electrical current to electrical components that would be mechanically attached to the glass sheet 22 or coated glass sheet 42. An example electrical component would be a capacitive moisture sensing unit on the sheets 22, 42.

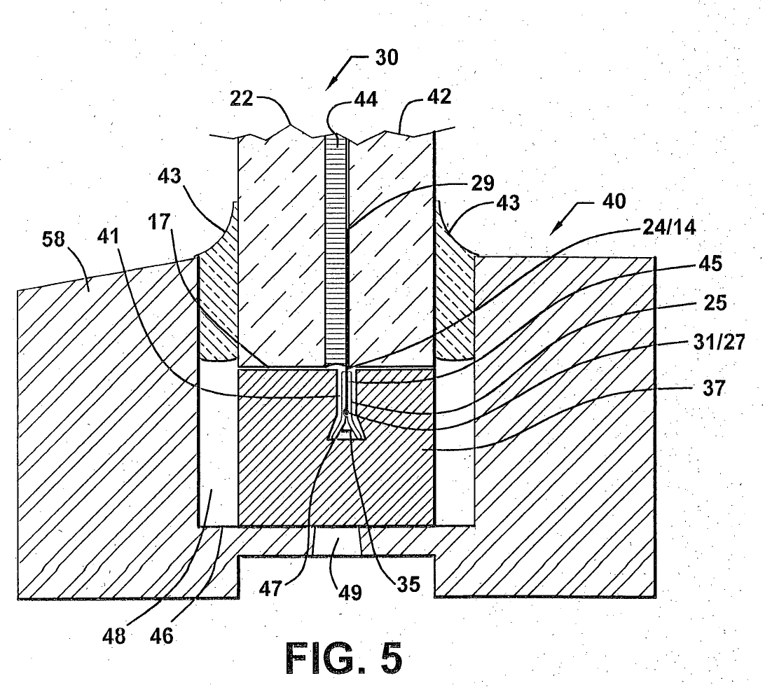

Referring to FIG. 5, there is shown a first glazing channel 40, which is an assembly of three subassemblies in accordance with again a further aspect of the present invention: (1) the laminated glass solar panel 30 (the insulated glass solar panel 20 or combination laminated and/or IG panel may be employed as well), (2) a base setting block 37, and (3) a glazing channel base 58. In FIG. 5, the laminated glass solar panel 30 is shown having the metallic tab 14 and the metal foil 24 disposed within the interlayer 44, where the metal foil 24 is disposed from the sight line 29 to the glass panel peripheral edge 17 and onto the exterior portions of the metallic tabs 14, so as to keep the metal foil 24 out of the sight of users.

As shown in FIG. 1a, the portion of the metal foil 24a that is disposed on a particular metallic tab 14 may not be in direct electrical contact with the other portion of metal foil 24b., within the same laminated glass solar panel 30. This separation of the portions of the metal foil 24a, 24b may be required in order to allow the electrical current (I) to be conducted through one metallic tab 14 and its corresponding bus bar 12, the conductive coating 18, the solar layers 16, another bus bar 12, and its corresponding metallic tab 14.

External to the laminated glass solar panel 30, both the metallic tab 14 and the metal foil 24 are shown extending from the glass panel peripheral edge 17. The deposition of the metal foil 24 and the metallic tab 14, as described, causes the two to be in electrical contact with each other, thus providing a measure of redundancy. In addition, FIG. 5 shows the metal foil 24 and the metallic tab 14 being mechanically clasped by opposing inside clasping surfaces 45 of a connection clip 25, the clasping by the clasping surfaces 45 being a result of a spring 35 urging the connection clip 25 about a pivot 47.

The extension of the spring 35 is a result of a movement of the connection clip 25 within the base setting block 37, wherein the base setting block 37 is formed so as to define at least a widened portion of a block cavity 41. As a result of the aforementioned movement, the laminated glass solar panel assembly 30 and the base setting block 37 abut to form an assembly. Subsequently, the abutment of the laminated glass panel 30 and the base setting block 37 are further abutted to a glazing channel surface 46 that is positioned to define at least a portion of a first glazing channel cavity 48 within a glazing channel base 58.

To further assure that the wiring of the laminated glass solar panels 30 is hidden from the view of the user and to allow moisture to drain out and away from the laminated glass solar panels 30, wiring/drain holes 49 may be provided in the glazing channel base 58, preferably at the time of manufacturing, so as to minimize the need to drill holes in the laminated glass solar panels 30 during installation in a structure or the like.

Unbonded areas (UBAs) may form on the aforementioned assembly, which can result in: (a) moisture entering, (b) glass chipping, (c) glass swelling, and (d) electrical connections being adversely affected. In the present invention, a glazing seal 43 is preferably disposed in assembly voids to minimize the negative effects of UBA.

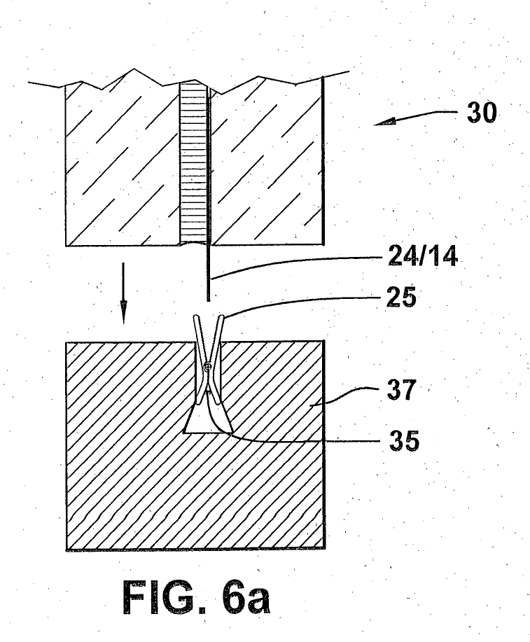

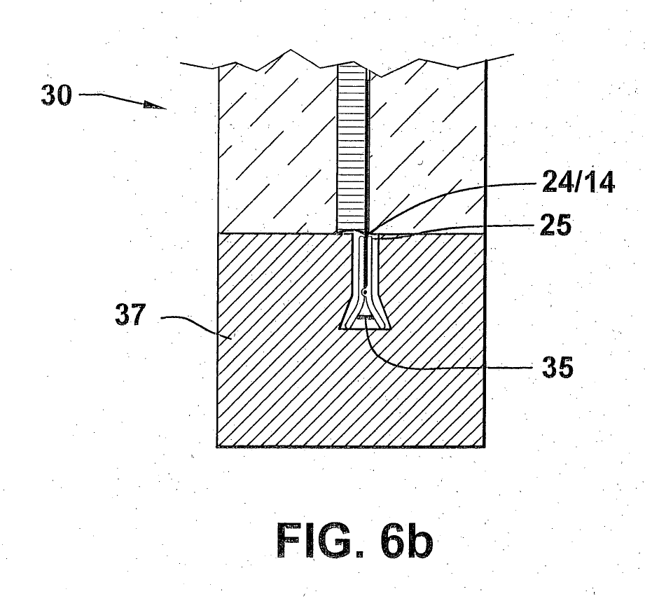

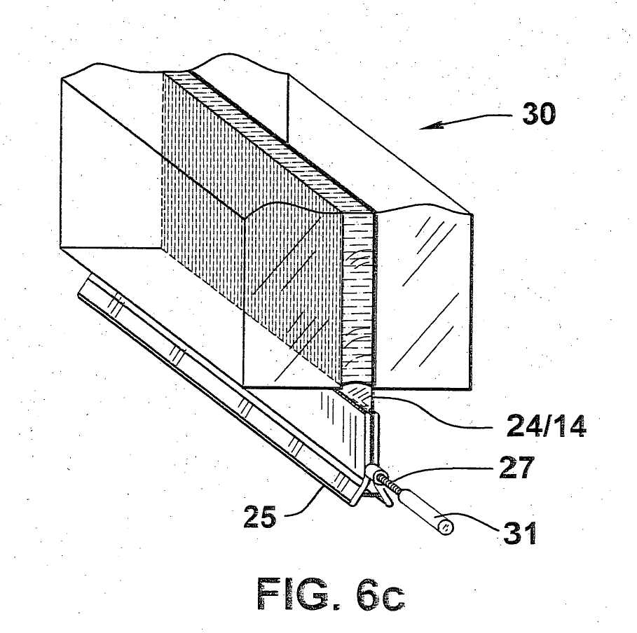

As illustrated in FIGS. 6a-6c, there is shown the laminated glass solar panel 30 (the insulated glass solar panel 20 or combination laminated and/or IG panel may be employed as well) being brought into abutment and electrical connection with the base setting block 37 and the connection clip 25 in accordance with FIG. 5. FIG. 6a shows a cross sectional view of a partially closed connection clip 25 where the spring 35 is only partially extended. Also shown is the laminated glass solar panel 30 approaching the base setting block 37, wherein the attached metal foil 24 and metallic tab 14 are about to be clasped by the partially open connection clip 25 and its partially extended spring 35.

As the laminated glass solar panel 30 and the connection clip 25 move into full attachment, the cross sectional view of FIG. 6b shows the complete clasping of the metal foil 24 and the metallic tab 14 by the connection clip 25 along with the full extension of the spring 35. Also shown in this view are the laminated glass solar panel 30 and the base setting block 37 in full abutment.

FIG. 6c is a perspective view in accordance with FIG. 6b showing further details of the laminated glass solar panel 30 having the metal foil 24 and metallic tab 14 fully clasped by the connection clip 25 while showing an extension of the channel connector 27 with insulating sleeve 31 attached to the connection clip 25 at the pivot 47 of the connecting clip 25. The channel connector 27, along with the insulating sleeve 31, may act to interconnect a plurality of base setting blocks 37. Consequently, a plurality of laminated glass solar panels 30 would be interconnected within the integrated connection circuit 11, for example, by conventional means in the art.

The above discussion on the interconnection of the laminated glass solar panel 30, by way of the metal foil 24, the metallic tab 14, the connection clip 25, and the spring 35, in conjunction with the base setting block 37, applies to heated glass panels as well.

Further, FIG. 7 shows a side view of the electrical and mechanical connection of the laminated glass solar panel 30 (the insulated glass solar panel 20 or combination laminated and/or IG panel may be employed as well), where the metal foil 24 covers the electrical connection for each metallic tab 14, thus providing a measure of electrical redundancy, from within the laminated glass solar panel 30, starting at the sight line 29, and then externally covering the extension of the metallic tabs 14.

Subsequently, the metallic tabs 14 mate with the connection clips 25, which are embedded in the first glazing channel 40, as shown in FIG. 1a. The mechanical connection between the laminated glass solar panel 30 and the base setting block 37 is achieved by a mating of the panel setting blocks 28, shown in FIGS. 1 and 7, and the base setting indentations 33, as shown in FIG. 1b.

In combination, FIGS. 8 and 9 illustrate how an interconnect 80, which is part of the integrated connection circuit, uses a multiple panel wiring 60 of the present invention to interconnect multiple laminated glass solar panels 30. Channel conductors 27 and push-on connectors 52, in combination with the metal foil 24 and the connection clips 25, provide ease and redundancy to accomplish the interconnection of multiple laminated glass solar panels 30. Even though FIG. 8 shows a thermocouple 55 and a circuit breaker 51, these items would be more applicable to the case of heated glass panels, as opposed to glass solar panels. However a power switch 53 would be used for glass solar panels 30 as a manual means to abate the flow of the electrical current (I), within the integrated connection circuit 11. In place of the thermocouple 55 and power switch 53, the glass solar panels 30 would only use wiring that would continue to the push-on connectors 52.

By incorporating the wiring of the laminated glass solar panel 30 into the base setting block 37 and providing the easy and redundant multiple panel wiring 60, the present, invention eliminates the difficulty of making electrical connections by eliminating the hole drilling process into the glass sheet 22 or coated glass sheet 42, prior to lamination, which is typically done to expose the bus bars 12 for connection to the electrical load 26.

Instead, the present invention uses the metallic tabs 14 and metal foil 24, described herein, that are easily incorporated into the integrated connection circuit 11, where the wiring connections between parts of the integrated connection circuit 11 may have flexible boots (not shown) encasing the connections, and conventional glazing sealant (not shown) may be used to attach the flexible boots to the glass panel peripheral edge 17, so as to minimize mechanical wear and accumulation of moisture. The flexible boots, with enclosed wiring, may be dressed through conventional gaskets or sealed with sealant and then terminated in National Electrical Code (NEC) electrical wiring boxes.

Typically, the internal integrated connection circuit 11 will be completed during manufacturing, so as to minimize the need for on-site electricians doing system wiring at the time of field installation. Instead, electricians would need to simply verify correct connection and terminate electrical load wiring at the time of field installation. Whereas, glaziers would be the primary installers of the glass solar panels 15 by glazing the wiring, boots, frames, and panels, which should preserve manufacturing integrity and improve reliability of the glass solar panels 15.

FIG. 10 shows a cross sectional view of an installation of a single laminated glass solar panel 30 within a second glazing channel 40′. However, it can be appreciated that multiple laminated glass solar panels 30, multiple insulated glass solar panels 20, or combinations of the panels 20, 30 could be realized in this aspect of the present invention. Also, these panels 20 may be used in heated glass and switchable glass. In addition, this aspect may be applied to architectural glazing as well as cladding material.

As shown, the laminated glass panel 30, along with various parts of the second glazing channel 40′ are disposed on the channel frame 67. A portion of the laminated glass panel 30 is shown being disposed within the second glazing channel cavity 48′ and abutting the channel frame 67, wherein the metallic tab 14 extends beyond the periphery of the panel 30. Mechanically and electrically disposed on the metallic tab 14 is a spade connector 96, which is mechanically and electrically disposed on an end of a channel conductor 27.

The channel conductor 27 is shown being disposed within the channel conduit 95 that passes through a coupler 91, which secures the channel conduit to the conductor block 93 and prevents moisture and dirt from entering the conductor block 93. Within the conductor block 93 a second end of the channel conductor 27 may be mechanically and electrically disposed on the multiple channel wiring 60 (shown in FIG. 9 where push-on connectors 52 are employed) or by conventional means in the art on the channel conductors 27 that are part of the interconnect 80 (shown in FIG. 8).

Multiple connections, as FIG. 10 illustrates, may be provided in each of the glazing channels 40, 40′, in order to assure the measure of redundancy of the electrical connectivity to the panels 30, since maintenance and removal of the panels 30 would be tedious and costly.

In accordance with the provisions of the patent statutes, the principles and mode of operation of this invention have been described and illustrated in its preferred embodiments. However it must be understood that the invention may be practiced otherwise than specifically explained and illustrated without departing from its spirit or scope.

1. A glass solar panel comprising:
a glass sheet;
an electrically conductive coating disposed on at least one major surface of the sheet;
at least two conductive metal bus bars disposed, by way of a circularly rotating heating head and mask apparatus, onto at least one major surface of the coating and in electrical contact with the coating; and
a solar layer disposed onto the coating and electrically connected between a first of the at least two bus bars and a second of the at least two bus bars.

2. The glass solar panel of claim 1, further comprising:
a first metallic tab disposed onto and in electrical contact with the first of the at least two bus bars and a second metallic tab disposed onto and in electrical contact with the second of the at least two bus bars;
wherein a portion of each tab extends beyond a peripheral edge of the sheet.

3. The glass solar panel of claim 1, wherein the electrically conductive coating comprises a doped metal oxide.

4. The glass solar panel of claim 1, wherein the at least two conductive metal bus bars comprise copper.

5. The glass solar panel of claim 1, wherein the at least two conductive metal bus bars taper toward a peripheral edge of the glass sheet.

6. The glass solar panel of claim 1, wherein the at least two conductive metal bus bars taper on end.

7. The glass solar panel of claim 1, wherein the glass sheet comprises clear soda-lime glass.

8. The glass solar panel of claim 1, wherein the glass sheet comprises low iron soda-lime glass.

9. The glass solar panel of claim 1, wherein the glass sheet comprises borosilicate glass.

10. The glass solar panel of claim 1, wherein the solar layer comprises amorphous silicon.

11. The glass solar panel of claim 1, wherein the solar layer comprises germanium.

12. The glass solar panel of claim 1, wherein the solar layer comprises cadmium telluride.

13. A glass solar panel comprising:
a glass sheet;
an electrically conductive coating disposed on at least one major surface of the sheet;
at least two conductive metal bus bars disposed, by way of an inline heating head and mask apparatus, onto at least one major surface of the coating and in electrical contact with the coating; and
a solar layer disposed onto the coating and electrically connected between the first of the at least two bus bars and the second of the at least two bus bars.

14. A glass solar panel comprising:
a first glass sheet;
an electrically conductive coating disposed on at least one major surface of the first sheet;
at least two conductive metal bus bars disposed, by way of a circularly rotating heating head and mask apparatus, onto at least one major surface of the coating and in electrical contact with the coating;
a first metallic tab disposed onto and in electrical contact with a first of the at least two bus bars and a second of the at least two metallic tabs is disposed onto and in electrical contact with a second of the at least two bus bars;
a solar layer disposed onto the coating and electrically connected between the first of the at least two bus bars and the second of the at least two bus bars; and
a second glass sheet laminated to the first sheet with a polymeric interlayer therebetween.

15. The glass solar panel of claim 14, wherein the polymeric interlayer comprises polyvinyl butyral.

16. A glass solar panel comprising:
a first glass sheet;
an electrically conductive coating disposed on at least one major surface of the first sheet;
at least two conductive metal bus bars disposed, by way of an inline heating head and mask apparatus, onto at least one major surface of the coating and in electrical contact with the coating;
a first metallic tab disposed onto and in electrical contact with a first of the at least two bus bars and a second of the at least two metallic tabs is disposed onto and in electrical contact with a second of the at least two bus bars;
a solar layer disposed onto the coating and electrically connected between the first of the at least two bus bars and the second of the at least two bus bars; and
a second glass sheet laminated to the first sheet with a polymeric interlayer therebetween.

17. A glass solar panel comprising:
a first glass sheet;
an electrically conductive coating disposed on at least one major surface of the sheet;
at least two conductive metal bus bars disposed, by way of a heating head and mask apparatus, onto at least one major surface of the coating and in electrical contact with the coating;
a first metallic tab disposed onto and in electrical contact with a first of the at least two bus bars and a second metallic tab disposed onto and electrically connected with a second of the at least two bus bars;
a solar layer disposed onto the coating and electrically connected between the first of the at least two bus bars and the second of the at least two bus bars; and
a second glass sheet in a parallel spaced apart relationship with the first sheet, and separated from the major surface of the first sheet by an insulating spacer seal unit that is disposed around at least a portion of a periphery therebetween.

18. The glass solar panel of claim 17, wherein the heating head and mask apparatus comprises a circularly rotating heating head and mask apparatus.

19. The glass solar panel of claim 17, wherein the heating head and mask apparatus comprises an inline heating head and mask apparatus.

20. The glass solar panel of claim 17, wherein the inline heating head and mask apparatus includes a belt-based inline heating head and mask apparatus.

21. A glass solar panel comprising
a first glass sheet;
an electrically conductive coating disposed on at least one major surface of the first sheet;
at least two conductive metal bus bars disposed onto at least one major surface of the coating and in electrical contact with the coating;
a first metallic tab disposed onto and in electrical contact with a first of the at least two bus bars and a second metallic tab disposed onto and electrically connected with a second of the at least two bus bars;
a solar layer disposed onto the coating and electrically connected between the first and the second of the at least two bus bars;
a second glass sheet in parallel arrangement with the major surface of the first sheet; and
a glazing channel capable of making mechanical and electrical contact with the panel.

22. The glass solar panel of claim 21, further comprising a polymeric interlayer therebetween the sheets.

23. The glass solar panel of claim 21, wherein the glazing channel comprises:
at least one connection clip having clasping surfaces, a pivot, and a spring, the spring capable of rotatably connecting and separating the clasping surfaces about the pivot;
a channel conductor, the conductor mechanically disposed on and in electrical contact with the pivot;
a base setting block having a block cavity defined therein, the block cavity having a narrow portion and a wide portion;
the spring capable of compressing when the clip is positioned in the narrow portion, wherein the clasping surfaces become separated;
the spring capable of expanding when the clip is positioned in the wider portion, wherein the clasping surfaces become connected;
at least one base setting indentation defined within the base block;
at least one panel setting block disposed on a peripheral edge of the panel;
metal foil disposed on and in electrical contact with the metallic tabs and the coating, from the peripheral edge of and within the panel, up to a sight line;
the foil being clasped by and in electrical contact with the clip and the panel setting block being mechanically mated with the base setting indentation when the panel and the base setting block are brought into an abutment at the panel peripheral edge; and
a glazing channel base;
wherein the abutment further abuts a glazing channel surface within a glazing channel cavity defined within the glazing channel base.

24. The glass solar panel of claim 23, wherein the metal foil comprises copper.

25. The glass solar panel of claim 23, wherein the glazing channel comprises:
a channel frame having a, channel cavity defined therein;
at least one conductor block disposed on the channel frame and having interconnecting conductors disposed within; and
a channel conduit having at least one channel conductor disposed therein and mechanically attached at a first end to the channel cavity and mechanically attached at a second end to one of the conductor blocks;
wherein the panel is disposed within the channel cavity and one of the metallic tabs extends into the first end of the channel conduit, where a first end of the channel conductor is mechanically and electrically attached to the metallic tab, and a second end of the channel conductor is mechanically and electrically attached to one of the interconnecting conductors.

26. The glass solar panel of claim 25, wherein the bus bars are disposed by way of a circularly rotating heating head and mask apparatus.

27. The glass solar panel of claim 25, wherein the bus bars are disposed by way of an inline heating head and mask apparatus.
